(19) United States
(12) Patent Application Publication
(10) Pub. No.: US 2013/0166152 A1
(43) Pub. Date: Jun. 27, 2013

(54) Geographic Reference Detection and Performance Modification

(71) Applicant: David J. Butterworth, Wichita, KS (US)

(72) Inventor: David J. Butterworth, Wichita, KS (US)

(73) Assignee: AGCO Corporation, Duluth, GA (US)

(21) Appl. No.: 13/334,433

(22) Filed: Dec. 22, 2011

(51) Int. Cl. G06F 7/00

(52) U.S. Cl. 701/45; 701/1; 701/50

(57) ABSTRACT

Location information may be received and a location of a machine may be determined based on the location information. Once the location of the machine is determined, a performance characteristic of the machine may be modified based on the location of the machine.

### BACKGROUND

Over the years industrial and agricultural machines have incorporated advances in technology. The advances in technology have caused these machines to become increasingly complex. The added complexity has created new challenges for agricultural machine manufacturers and operators.

### BRIEF DESCRIPTION OF THE DRAWINGS

The accompanying drawings, which are incorporated in and constitute a part of this disclosure, illustrate various embodiments of the disclosure. In the drawings:

FIG. 1 is a diagram of an operating environment;

FIG. 2 is a performance modification processor;

FIG. 3 is a flow chart of a method for geographic reference detection and performance modification; and

FIG. 4 is a lookup table.

### DETAILED DESCRIPTION

### Overview

Geographic reference detection and performance modification may be provided. First, location information may be received and a location of a machine may be determined based on the location information. Once the location of the machine is determined, a performance characteristic of the machine may be modified based on the location of the machine.

Both the foregoing general description and the following detailed description are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the detailed description. -cl EXAMPLE EMBODIMENTS

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

A machine may be manufactured in a first location, but operated in a second location. The second location, however, may have, for example, government regulations regarding performance characteristic for the machine that may be different from the first location. For example, first world countries may have stricter emissions standards for the machine than third world countries. In addition, users in the first location may speak a different language than users in the second location. Consequently, it may be desirable for the machine to operate at different emission standards or for user interfaces on the machine to operate in different languages based on the machine's location.

As the machine moves from location to location, devices (e.g. Global Positioning Satellites (GPS) devices) may be used to obtain location information corresponding to the machine's location. With this location information, a computer (e.g. an engine control unit (ECU)) may modify a performance characteristic for the machine. For example, language warning messages or instructions presented by the machine may be presented in English rather than Spanish based upon the location information.

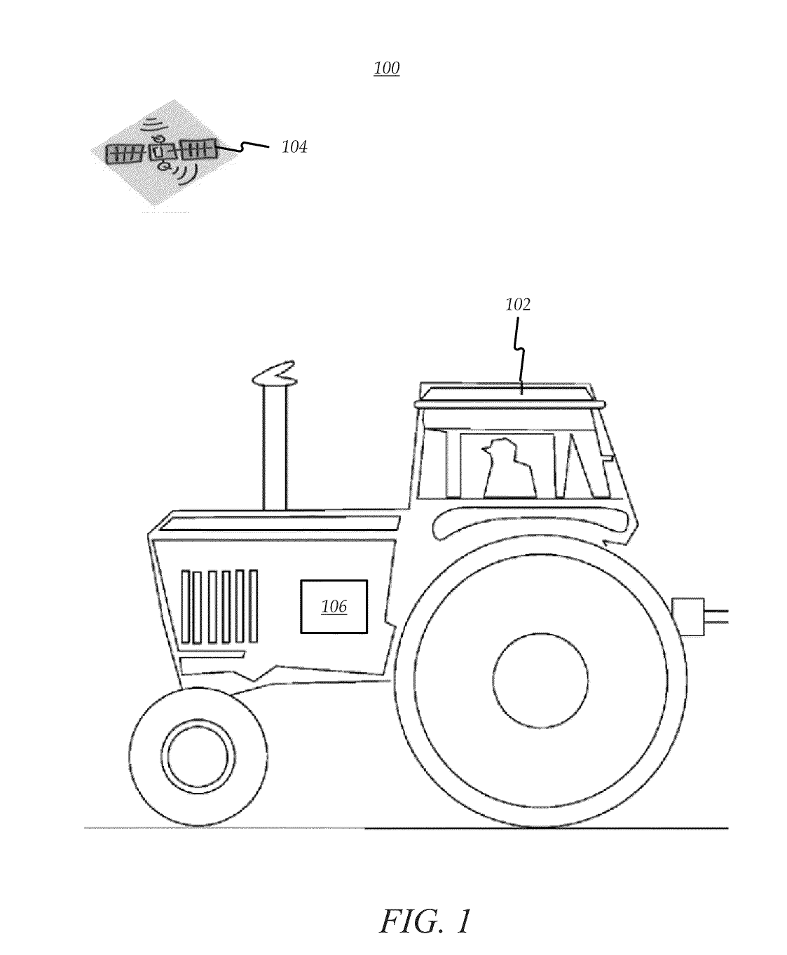

FIG. 1 is a diagram of an operating environment 100. As shown in FIG. 1, operating environment 100 may comprise a machine 102 and a source 104. Machine 102 may comprise a performance modification processor 106. Performance modification processor 106 may calculate location information from data supplied by source 104. While FIG. 1 shown performance modification processor 106 being located on machine 102, embodiments of the invention are not so limited. For example, performance modification processor 106 may be located remotely from machine 102. In this case, machine 102 may receive the location information from source 104 and then transmit the location information to the remotely located performance modification processor 106.

Machine 102 may comprise any movable piece of equipment such as, for example, an agricultural implement (e.g., a tractor, a combine, a sprayer, or an implement towed behind a tractor, combine, etc.). Moreover, machine 102 may comprise industrial, construction, or transportation equipment. For instance, machine 102 may comprise a tractor-trailer truck, a train, or an airplane that may be used to haul freight and passengers to and from destinations such as from Canada to Central America or from France to China. The aforementioned are examples and machine 102 may comprise any machine or piece of equipment.

Source 104 may comprise governmental sources such as the Global Positioning Satellite (GPS) constellation maintained by the United States, the GLONASS system maintained by Russia, the Compass Navigation Systems maintained by China, the Galileo Positioning System maintained by the European Community, or the Indian Regional Navigational Satellite System maintained by India. Moreover, source 104 may comprise private sources, for example, cellular towers, radio towers, and satellite radio systems. The aforementioned are examples and source 104 may comprise anything capable of providing location information.

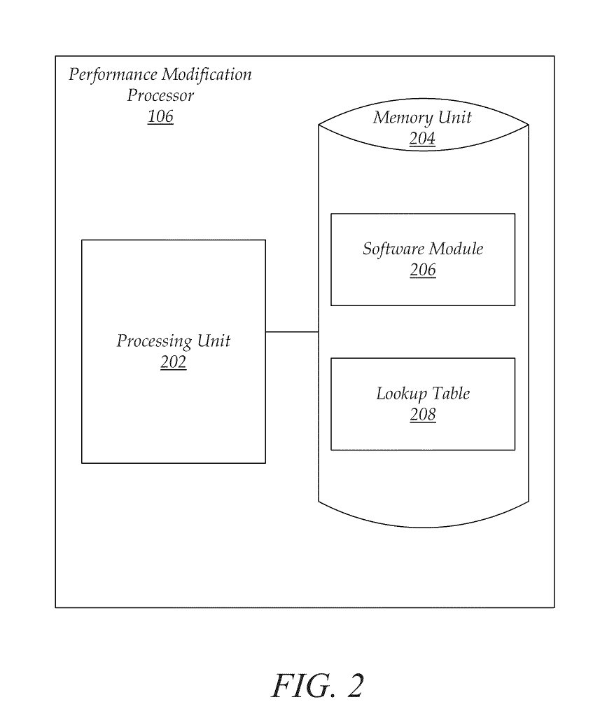

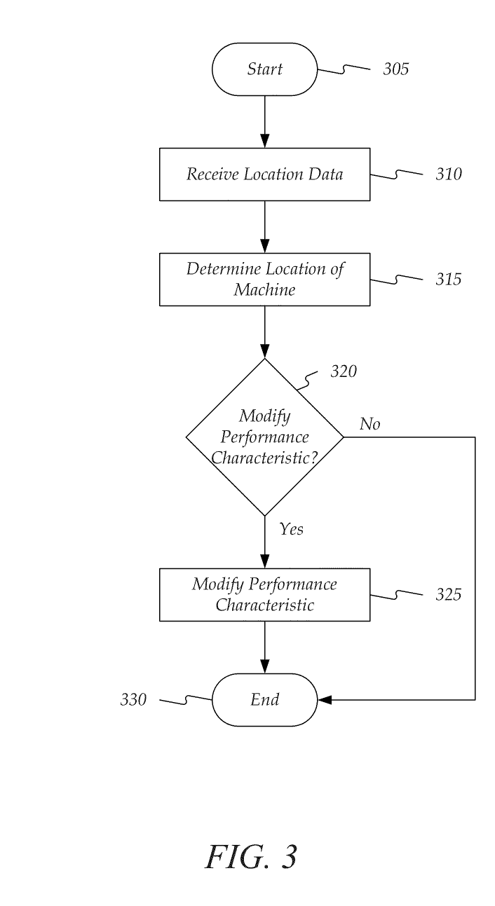

FIG. 2 shows performance modification processor 106 in more detail. As shown in FIG. 2, performance modification processor 106 may include a processing unit 202 and a memory unit 204. Memory unit 204 may include a software module 206 and a lookup table 208. While executing on processing unit 202, software module 206 may perform processes for providing geographic reference detection and performance modification, including, for example, one or more stages included in method 300 described below with respect to FIG. 3.

Performance modification processor 106 (“the processor”) may be implemented using an onboard electronic control unit (ECU), a personal computer, a network computer, a mainframe, or other similar microcomputer-based workstation. The processor may be located on machine 102 or may be in a remote location. For instance, in an agricultural environment, the processor may comprise a computer located at a central location (e.g., a farm's central equipment storage and maintenance facility). In this case, machine 102 may receive the location information from source 104 and then transmit the location information to the remote processor.

The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, or a wireless fidelity (Wi-Fi) access point. The aforementioned systems and devices are examples and the processor may comprise other systems or devices.

FIG. 3 is a flow chart setting forth the general stages involved in a method 300 for geographic reference detection and performance modification. Method 300 may be implemented using, for example, performance modification processor 106 as described in more detail above. Ways to implement the stages of method 300 will be described in greater detail below.

Method 300 may begin at starting block 305 and proceed to stage 310 where performance modification processor 106 may receive location information. For example, after starting machine 102, performance modification processor 106 may receive the location information from a government maintained source (e.g., GPS signal) or a privately maintained source (e.g., a cell tower).

From stage 310, where performance modification processor 106 received the location information, method 300 may advance to stage 315 where performance modification processor 106 may determine a location of machine 102 based on the location information. For example, performance modification processor 106 may receive time information from four GPS satellites. Using the time information, performance modification processor 106 may determine a latitude, a longitude, and an altitude of machine 102.

Using the latitude and the longitude, performance modification processor 106 may access lookup table 208. For example, based on a location defined by the latitude, a longitude, modification processor 106 may cross reference to lookup table 208 for a corresponding geographic reference shape data 402. Geographic reference shape data 402 may include, for example, shape files outlining the boundaries for the various municipalities. As an example, performance modification processor 106 may determine the latitude and longitude of machine 102 and compare that coordinate with geographic reference shape data 402. If the coordinate is within a boundary of a municipality, performance modification processor 106 may determine that machine is in the municipality. For instance, performance modification processor 106 may determine that machine 102 may be located at a 38° N, 97° W and utilizing a shape file containing boundaries for the United States, the various states, or cities within the various states, performance modification processor 106 may determine that machine 102 is located in the United States, Kansas, or Hesston, Kans.

Performance modification processor 106 may also receive information from more than one source. For instance, performance modification processor 106 may receive time information from both, four GPS satellites and two cell towers. The location information may be used to triangulate machine 102's position, which may be cross-referenced with a position determination based on the four GPS satellite signals. If the triangular position differs from the GPS determined position, an operator may be alerted by an audible or visual alarm.

Once performance modification processor 106 has determined the location of machine 102 in stage 315, method 300 may continue to decision block 320 where performance modification processor 106 may determine if a performance characteristic needs to be modified. For example, at startup, machine 102 may have been located in North Dakota. While working in a particular field, performance modification processor 106 may determine, in stage 315, that machine 102 has crossed into Canada. Upon crossing into Canada, a performance characteristic of machine 102 may need to be modified. For instance, a regulatory body in Canada may have established emissions standards that differ from the United States. As a result, when machine 102 crosses into Canada, the engine performance of machine 102 may need to be modified.

To determine if a performance characteristic needs to be modified, performance modification processor 106 may compare the determined location with geographic reference shape data 402. For example, at a previous time, performance modification processor 106 may have determined that machine 102 may have been located in the United States. At the present time, performance modification processor 106 may have determined that machine 102 is now located in Canada.

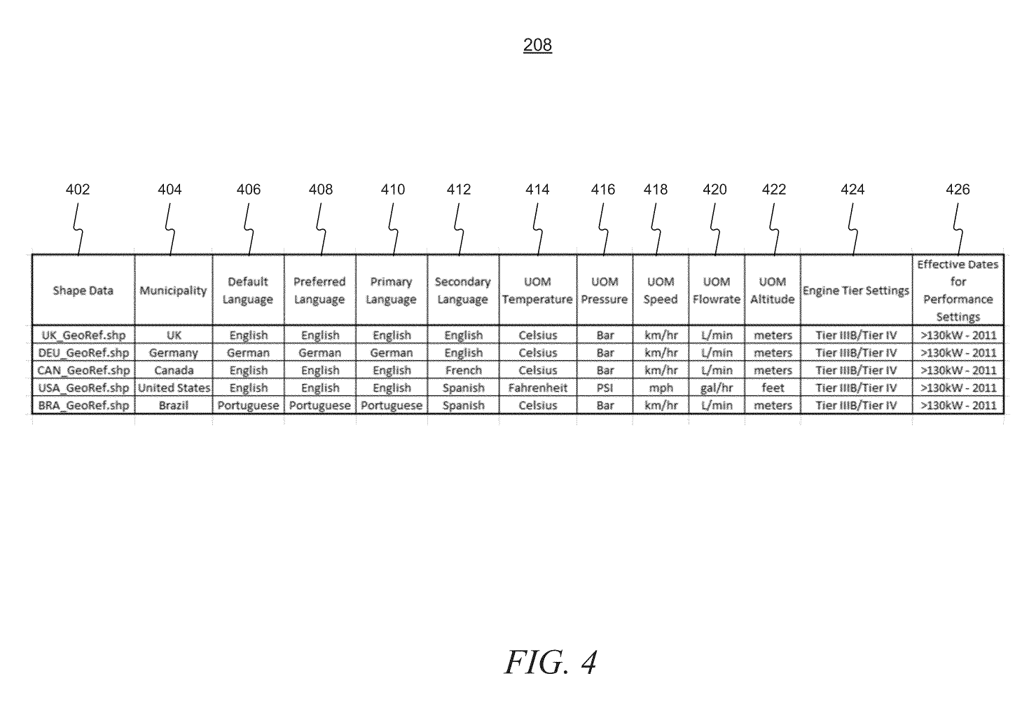

Using lookup table 208, performance modification processor 106 may determine that Canada may have different performance requirements. For instance, lookup table 208, (as shown in FIG. 4) may comprise geographic reference shape data 402, names of various municipalities 404 (e.g., countries, states, and cities), language preferences (e.g., default language 406, preferred language 408, primary language 410, and secondary language 412), various units of measure (UOM) (e.g., temperature 414, pressure, 416, speed 418, flow rate 420, and altitude 422), engine tier settings 424, and effective dates for performance settings 426.For example, using the data in lookup table 208, performance modification processor 106 may determine that, based on machine 102's location, engine tier settings 424 need to be modified because the current date may be past the effective dates for performance settings 426.

Effective dates for performance settings may be established by government regulatory bodies or private entities as well. Engine tier settings may be established by a government regulatory body (e.g., the Environmental Protection Agency (EPA)), or private groups. In addition, a new engine tier for engine emissions established by the EPA or other governing body may go into effect on a particular date and either apply or not apply to machines produced after a certain date. For instance, Tier IV emissions standard may go into effect on Jan. 1, 2011 and apply to all farm equipment manufactured after Jan. 1, 2009. During routine software updates, lookup table 208 may be updated and a tractor produced in June, 2009 may begin operating at Tier IV levels. A combine, produced in May, 2008 may receive, during routine software updates, an updated version of lookup table 208, but still continue to operate at Tier III levels. Other examples of performance settings that may be updated when lookup table 208 is updated include speed limits, maximum/minimum airspeeds, and altitude restrictions.

Yet, another example of when a performance characteristic may need to be modified may be during startup procedures. For example, during its last operation, machine 102 may have traveled from France to Germany. When machine 102 was started in France, its display instruments may have displayed, for example, operating notices, warning messages, and instructions in French. During use or after shutting down, machine 102 may have been relocated (e.g., either during use or shipped) to Germany. When machine 102 is restarted in Germany, performance modification processor 106, at decision block 320, may determine that a performance characteristic (e.g., language) may need to be changed. In this instance at startup, display instruments may display, for example, operating notices, safety warning messages, and instructions in German.

In addition to performance modification processor 106 automatically modifying a performance characteristic, a user may be presented with a choice to select the performance characteristic modification based on location. For example, at stage 310 performance modification processor 106 may receive location information and at stage 315 performance modification processor 106 may determine that machine is located where multiple languages are spoken (e.g., Texas (English and Spanish) or Switzerland (French and German)). At decision block 320, performance modification processor 106 may present the user with a language choice (e.g., between English and Spanish or French and German). The decision, at decision block 320, may be made by the user instead of automatically made by performance modification processor 106.

At decision block 320, if performance modification processor 106 determined that the performance characteristic needs to be modified, method 300 may proceed to stage 325 where performance modification processor 106 may modify the performance characteristic. For example, performance modification processor 106 may determine, at decision block 320, that machine 102′s engine needs to be D-rated because machine 102 may have relocated from one country to another. Therefore, at stage 325 performance modification processor 106 may change machine 102's engine tier from Tier III to Tier IV.

After modifying the performance characteristic in stage 325 or determining, at decision block 320, that the performance characteristic does not need to be modified, method 300 may then terminate at stage 330.

Method 300 may be performed by performance modification processor 106 at a preset time (e.g., a single instance in time, regular intervals, or varying intervals). For example, the preset time may be any increment of time and may be set by, for instance, the user or machine 102's manufacturer. A longer preset time may be used for a machine that may not travel great distances. For instance, if machine 102 is a combine owned by a family farm, the present time may be, for example, one-year or longer. A shorter preset time may be used for machines that may travel great distances at slower speed. For instance, machine 102 may be, for example, a tractor-trailer truck or a train and the preset time may be, for instance, 30 minutes or hour. Short preset times may also be used for machines that may travel great distances at high speed. For example, machine 102 may be, for example, an airplane and the preset time may be, for instance, every second or half a second.

An embodiment may comprise a method. The method may comprise receiving location information. After receiving the location information, a location of a machine may be determined based on the location information. Once the location of the machine is determined, a performance characteristic of the machine may be modified based on the location of the machine.

Another embodiment may comprise a system. The system may comprise a memory storage and a processing unit coupled to the memory storage. The processing unit may be operative to receive location information. After the processor has received the location information, the processor may determine a location of a machine based on the location information. After determining the location, the processor may modify a performance characteristic of the machine based on its location.

Yet another embodiment may comprise a non-transitory computer readable medium comprising logic. The logic may be operative to receive location information. After receiving the location information, the logic may be operative to determine a location of a machine based on the location information. After determining the location, the logic may be operative to modify a performance characteristic of the machine based on its location.

Embodiments, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments have been described, other embodiments may exist. Furthermore, although embodiments have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

Both the foregoing general description and the following detailed description are examples and explanatory only, and should not be considered to restrict the invention's scope, as described and claimed. Further, features and/or variations may be provided in addition to those set forth herein. For example, embodiments may be directed to various feature combinations and sub-combinations described herein.

Embodiments, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

All rights, including copyrights, in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example embodiments.

What is claimed is:

1. A method comprising:
receiving location information;
determining a location of a machine based on the received location information; and
modifying a performance characteristic of the machine based on the determined location of the machine.

2. The method of claim 1, wherein receiving the location information comprises receiving the location information from a government maintained source.

3. The method of claim 2, wherein receiving the location information from the government maintained source comprises receiving the location information from at least one of Global Positioning Satellite signals, GLONASS, Compass Navigation Systems, Galileo Positioning System, or Indian Regional Navigational Satellite System.

4. The method of claim 1, wherein receiving the location information comprises receiving the location information from a privately maintained source.

5. The method of claim 4, wherein receiving the location information from the privately maintained source comprises receiving cellular location data.

6. The method of claim 1, wherein modifying the performance characteristic of the machine based on the location of the machine comprises setting a default language for a safety warning.

7. The method of claim 1, wherein modifying the performance characteristic of the machine based on the location of the machine comprises setting an engine tier established by a government regulatory body.

8. The method of claim 1, wherein modifying the performance characteristic of the machine based on the location of the machine comprise:
prompting a user for a language selection; and
receiving the language selection from the user.

9. The method of claim 8, wherein prompting the user for the language selection comprises presenting the user with a list of languages.

10. The method of claim 1, wherein modifying the performance characteristic of the machine based on the location of the machine comprises modifying the performance characteristic of an implement attached to the machine.

11. An apparatus comprising:
a memory storage; and
a processing unit coupled to the memory storage, wherein the processing unit is operative to:
receive location information,
determine a location of a machine based on the location information, and
modify a performance characteristic of the machine based on the location of the machine.

12. The apparatus of claim 11, wherein the processing unit being operative to receive the location information comprises the processing unit operative to receive the location information from a government maintained source.

13. The apparatus of claim 12, wherein the processing unit being operative to receive the location information from the government maintained source comprises the processing unit operative to receive the location information from at least one of Global Positioning Satellite signals, GLONASS, Compass Navigation Systems, Galileo Positioning System, or Indian Regional Navigational Satellite System.

14. The apparatus of claim 11, wherein the processing unit being operative to modify the performance characteristic of the machine based on the location of the machine comprises the processing unit operative to set a default language for a safety warning.

15. The apparatus of claim 11, wherein the processing unit being operative to modify the performance characteristic of the machine based on the location of the machine comprises setting an engine tier established by a government regulatory body.

16. The apparatus of claim 11, wherein the processing unit being operative to modify the performance characteristic of the machine based on the location of the machine comprises the processing unit operative to:
prompt a user for a language selection; and
receive the language selection from the user.

17. The apparatus of claim 16, wherein the processing unit being operative to prompt the user for the language selection comprise presenting the user with a list of languages.

18. An apparatus comprising:
a movable piece of farm equipment comprising:
a memory storage; and
a processing unit coupled to the memory storage, wherein the processing unit is operative to:
receive location information,
determine a location of movable piece of farm equipment based on the location information, and
modify a performance characteristic of the movable piece of farm equipment based on the location of the movable piece of farm equipment.

19. The apparatus of claim 18, wherein the processing unit being operative to modify the performance characteristic of the machine based on the location of the machine comprises the processing unit operative to:
prompt a user for a language selection; and
receive the language selection from the user.

20. The apparatus of claim 18, wherein the processing unit being operative to modify the performance characteristic of the machine based on the location of the machine comprises the processing unit operative to set a default language for a safety warning.
